(19) United States
(12) Patent Application Publication
(10) Pub. No.: US 2008/0059990 A1
(43) Pub. Date: Mar. 6, 2008

(54) Behavioral attention control apparatus

(76) Inventors: John N. Marr, Fayetteville, AR (US); Kenneth T. Joyce, Ahwahnee, CA (US); John B. Peters, Campbell, CA (US); Charles F. Weber, Los Gatos, CA (US); Daniel A. Attema, Soquel, CA (US); Otto L. Dalmady, San Jose, CA (US)

Correspondence Address: WRIGHT, LINDSEY & JENNINGS LLP, 200 WEST CAPITOL AVENUE, SUITE 2300, LITTLE ROCK, AR, 72201-3699, US

(21) Appl. No.: 11/514,794

(22) Filed: Sep. 1, 2006

(51) Int. Cl. H04H 9/00

(52) U.S. Cl. 725/10; 348/553

(57) ABSTRACT

A behavioral attention control apparatus and method for treating the short attention span of a child viewing a television that requires the child to respond to an alert signal within a specific window period to prevent the television from turning off. A specialized remote control component has a switch that must be triggered by the child to initially turn on the television and then retriggered periodically to keep the television turned on. A timer defines a window period during which the child must make a valid retrigger. After an interval with the television on, the window period opens and the child is alerted to the opening of the window period by lights and sound. If a valid retrigger is not made during the window period, the television is turned off. The remote control component is desirably housed in an enclosure that would be appropriately attractive to a child. In one embodiment, the enclosure is shaped like a frog and the sound alert is a frog-like “ribbet” sound. The remote control component communicates via radio frequency (RF) signals with a television control component that receives the RF signals and communicates with the television via IR transmissions to the television's IR remote control receiver in order to turn the television on or off. The interval period during which the television remains on may be progressively lengthened if the child makes a valid retrigger during successive window periods.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention relates to an apparatus and method for treating the problem in children of short attention span that may be aggravated by television viewing, and in particular, to an apparatus and method that requires a child viewing a television to respond to a signal within a specific window period to prevent the television from turning off.

2. Brief Description of the Related Art

It is known that children may be susceptible to a short attention span and that this problem may be aggravated by television viewing.

Various devices are known that provide timing mechanisms to control the operation of electrical equipment.

For example, U.S. Pat. No. 6,323,777 to Durston et al. discloses a device and a method for the safe operation of electrical equipment. A primary timer energizes the electrical equipment for a preset primary interval of time. A secondary timer activates audible and visual alarms when a period of time less than the primary interval elapses. The secondary timer may be reset manually. Also, the primary timer may be reset and this acts to reset the secondary timer also.

U.S. Pat. No. 4,500,795 to Hochstein et al. discloses an electrical timing switch in which a predetermined time period for an electrical device to remain on is set. Before the end of the predetermined time period expires, the electrical device is turned off for one or more warning periods before the electrical device is turned completely off. If the switch is reactivated, the timer is set for another timing period.

U.S. Pat. No. 5,194,951 to Hailey et al. discloses a conventional sleep timer for a television in which display circuitry provides a reminder to a user by automatically reducing the area of the television picture before turning off the television. U.S. Pat. No. 5,153,580 to Pollack discloses a variation on the same invention in which the activation by the user of any remote control device that produces a modulated IR signal is accepted to reset the sleep timer. A further variation includes reducing the sound volume as a signal that the television is about to be turned off.

U.S. Pat. No. 5,142,358 to Jason discloses a device that allows a child to earn television viewing time by performing a positive task. When the child has performed a sufficient quantity of the task, the device sounds an audible signal that informs the child that the television or similar device may be viewed. The child is not under any time constraints to watch the television. If after viewing the television, the child wishes to earn more viewing time, the device will reset and more viewing time earned.

U.S. Pat. No. 4,541,519 to Belviso et al. discloses a variation on a conventional coin-operated timed device in which additional time can be purchased while the device is operating. It is not necessary for the timer to end operation of the device before more coins can be entered to purchase additional time. A visual display counts down the remaining time and an audible alarm sounds as the purchased time interval is about to elapse. Before the time elapses, the user can purchase additional time at a lower rate than would be required if the time were allowed to elapse.

U.S. Pat. No. 5,125,492 to Treleaven et al. discloses a device to control a child's viewing of television by using a token reward system. The parent provides a number of tokens to the child. Each token provides a certain quantity of viewing time when inserted into the controller device. The device provides an audible warning a predetermined time interval before the purchased time runs out.

U.S. Pat. No. 6,905,440 to Heppert discloses a device for motivating exercise. The device generates a signal proportional to the amount of exercise being undertaken and stores a accumulated amount to operate an devise such as a television for an amount of time proportional to the accumulated amount.

U.S. Pat. No. 3,611,344 to Couper discloses a system for maintaining the alertness of a driver of a vehicle. Couper discloses a timer which is activated when the ignition is turned on. After a predetermined period of time, a visual alarm is actuated. The driver must respond by pressing a switch to reset the timer. If the driver does not press the switch during a fixed interval, a second alarm system is activated. If the driver does not press the switch during the second fixed interval, the vehicle is deactivated and emergency flashers are turned on. After the vehicle is deactivated, it can be reactivated by a manual switch. The vehicle may be reactivated immediately by the driver without a delay period. The predetermined periods of time before the first alarm is activated may be reduced as the speed of the vehicle increases.

U.S. Pat. No. 6,179,746 to Delman discloses a device for controlling the operation of a television or the like by the user achieving a preset level of physical activity. For example, a stationary bicycle could be used to keep the television turned on so long as the user pedals above the preset rate.

U.S. Pat. No. 6,903,284 to Dunfield et al. discloses a timer that deactivates an item of electrical equipment after a predetermined period of time.

Operant conditioning is a known technique for conditioning an individual to perform a desired behavior on the principle that the frequency of such behavior will be increased if it is rewarded. Several techniques for scheduling rewards are also known. For example, the desired behavior may be reinforced by a reward on a continuous schedule where the behavior is reinforced each time it is performed. In addition to continuous schedules, reinforcement may also be intermittent. Intermittent schedules include ratio schedules where reinforcement is given after the desired behavior is performed a given number of times. In interval schedules, the first response after a given interval is reinforced. In interval schedules with limited hold, the reinforcement is given if the desired behavior occurs within a period at the end of the interval. If the interval is fixed, it is called a Fixed Interval with Limited Hold (FI-LH).

The limitations of the prior art are overcome by the present invention as described below.

### BRIEF SUMMARY OF THE INVENTION

This invention is directed to the problem of the short attention span of children that may be aggravated by television viewing. The invention requires the child to respond to a signal within a specific window period to prevent the television from turning off. The invention is directed to reducing attention problems and may have application to attention deficit disorder (ADD) and attention deficit hyperactivity disorder (ADHD).

The invention is an apparatus that may comprise two components to control the on/off operation of a television set. The first component is a specialized remote control that has a switch that must be triggered by the child to initially turn on the television and then must be retriggered periodically to keep the television turned on. The remote component has a timer that defines a periodic window during which the child must make a valid retrigger, i.e, a retrigger during the window, in order to keep the television on. This is based on an FI-LH schedule. The reinforcement or reward is the continuation of television viewing. A lack of response by the child during the limited hold period results in a time without television viewing until the child responds again. After an interval with the television on, the window opens and the child is alerted to the opening of the window period by lights and sound. For example, if the initial interval is set at 15 seconds, then the last 5 seconds of the interval could be the window (limited hold) period. The window period would be signaled, e.g., by a sound at the start of the window period with a light on during the entire 5 seconds.

The remote component is desirably housed in an enclosure that would be appropriately attractive to a child, such as animal shape. In one embodiment, the enclosure is shaped like a frog and the sound alert is a frog-like “ribbet” sound. The enclosure may be in the form of an enclosure with flexible wings or a flexible disc with an image of a frog.

The remote component communicates information to the second component, for example, via any means of wired or wireless communication. The second component is a television control component that communicates with the television via, for example, IR transmissions to the television's IR remote control receiver, in order to turn the television on or off.

Only one valid retrigger may be made during a window period. The time interval during which the television remains on may be progressively lengthened if the child makes a valid retrigger during consecutive successive window periods. For example, if during several window periods in succession, the child has made a valid retrigger, the interval becomes longer. If a valid retrigger is not made during a window period, the television is turned off and the interval is returned to its initial length. Optionally, there may be a delay period during which the television cannot be turned on immediately.

These and other features, objects and advantages of the present invention will become better understood from a consideration of the following detailed description of the preferred embodiments and appended claims in conjunction with the drawings as described following:

### BRIEF DESCRIPTION OF THE SEVERAL VIEWS OF THE DRAWINGS

FIG. 1 is a schematic diagram of a user interacting with an embodiment of the apparatus of the present invention showing the remote control component and a television plugged into the television control component.

FIG. 2A is a block diagram of the remote control component of one embodiment of the present invention. FIG. 2B is a block diagram of the television control component of one embodiment of the present invention.

FIG. 3 is a timing diagram showing the operation of the present invention. The user's or child's behavior (CB) is represented by “+” for a valid retrigger or switch closure. The window period is shown by an increase in the reference line “WP” and the “ON” and “OFF” states of the television are shown by an increase or decrease respectively in the reference line “TV.”

FIG. 4A is a perspective view of an embodiment of the remote control component of the present invention showing a frog-shaped enclosure. FIG. 4B is an exploded view of the embodiment of FIG. 4A.

FIG. 5 is a perspective view of an embodiment of the television control component of the present invention. FIG. 5B is an exploded view of the embodiment of FIG. 5A.

### DETAILED DESCRIPTION OF THE INVENTION

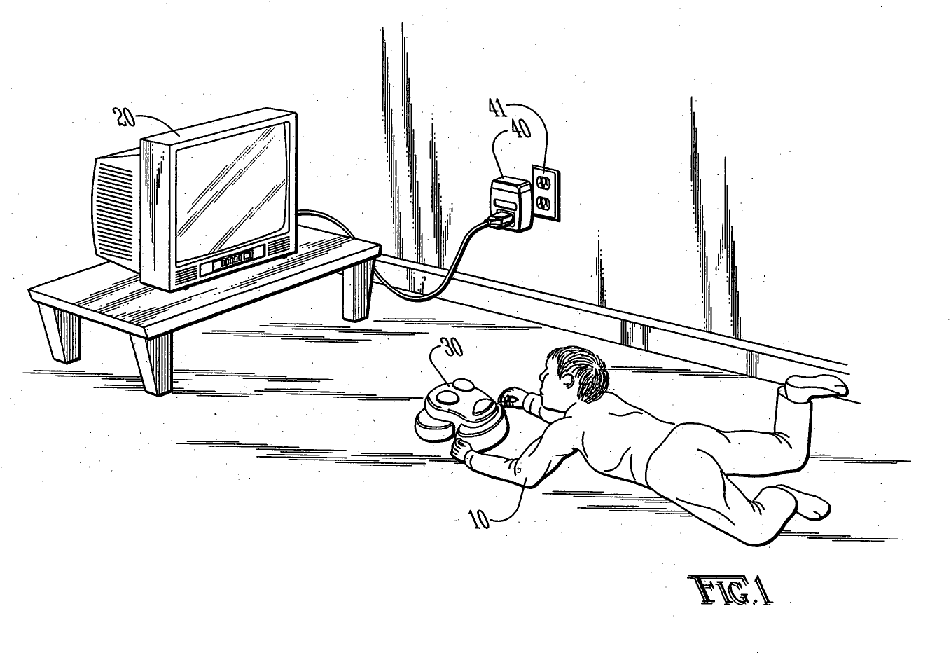

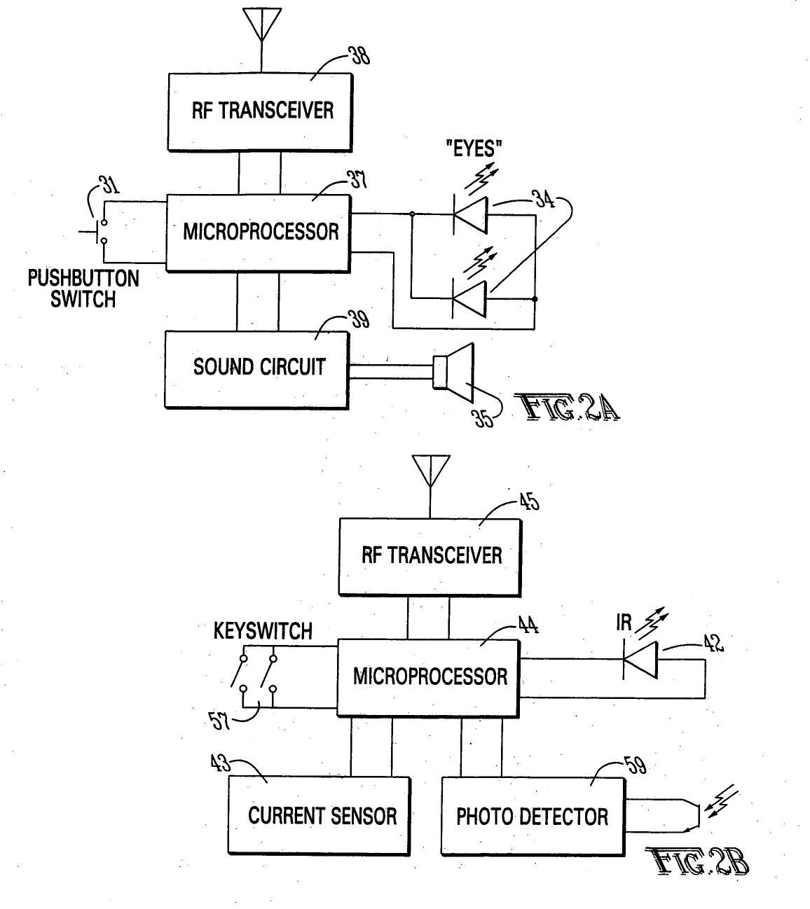

With reference to FIG. 1, the present invention is intended to be used by a user 10, particularly a child, to control the on/off function of a television 20. The television 20 may use infrared (IR) remote control. The present invention is not, however, limited to television controllers that use infrared remote control, but may include any means of controlling the on/off functions of a television. In a presently preferred embodiment, the device includes two separate components, although the components may be housed in a single enclosure.

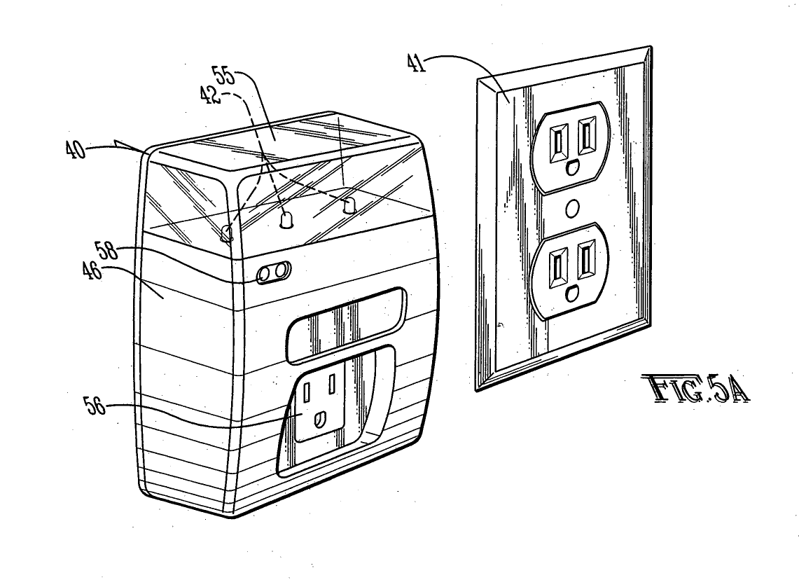

With reference to FIGS. 1, 2A, 3 and 4A-B, the first component is a remote control component 30 with a switch 31 that must be closed to initially turn the television 20 on and then closed afterwards during window periods to keep it on. It is desirable that the switch 31 be brightly colored to attract the attention of a child. A color such as yellow is suitable. The remote control component 30 contains circuitry that provides a timing function, defining an interval period during which the television 20 will remain on before it is turned off and a window period at the end of the interval period during which the user 10 must affect the switch closure in order to prevent the television 20 from turning off. The timing function may be implemented in a microprocessor 37. A visual and audible alert notifies the user 10 whenever the window period is open. The audible alert may be implemented in a sound circuit 39 and speaker 35. The remote control component 30 also contains a radio frequency (RF) transmitter (or, optionally, transceiver) 38 to transmit to a second component whenever a valid switch closure (valid retrigger) is made. The present invention is not limited to a remote control component 30 that communicates with a second component via RF. Any means by which information may be communicated among the switch 31, the timing function and the television controller is contemplated as being within the scope of the present invention, including without limitation, any form of wired or wireless communication. The functions of the remote control component 30 are desirably built into an enclosure 32 that would be attractive to a child, such as an animal shape. The enclosure 32 may be formed from an upper body 50 and a lower body 51. In the preferred embodiment, the enclosure 32 would be shaped like a frog. The remote control component 30 may be powered by a battery 33, preferably a rechargeable battery, thereby allowing it to be recharged in the same manner as a cell phone. Alternatively, the remote control component 30 may be powered from a wall outlet and in such a case, it is desirable that a control be included to allow the component to be alternated between battery power and line voltage. The remote control component 30 therefore desirably comprises the switch 31, means to produce a visible alert such as light emitting diodes (LEDs) 34, means to produce an audible alert such as a sound circuit 39, speaker 35 and speaker enclosure 53, a microprocessor 37 for the timing functions and an RF transmitter 38. The electronic functions may be located on a circuit board 52. When the remote control component 30 is housed in a frog-shaped enclosure 32, the visible alert may be in the form of LED's 34 that appear to light the frog's eyes 36 and the audible alert at the start of the window period may be in the form of a frog-like “ribbet” sound. The frog's eyes 36 are desirably formed of translucent material.

With reference to FIGS. 1, 2B, 3 and 5A-B, in a preferred embodiment, the second component is a television control component 40 and consists of a control enclosure that plugs into a wall outlet 41. The television 20 then plugs into the television control component 40. The television control component 40 contains a power supply (not shown), at least one IR transmitter 42 such as an LED for transmission to the television's IR receiver, a current sensor 43, an RF receiver (or, optionally, transceiver) 45 and control circuitry. The present invention is not limited to a television control component 40 that communicates with a remote control component 30 via RF or that communicates with a television via IR. Any means by which information may be communicated among the switch 31, the timing function and the television controller to control the on/off functions of the television is contemplated as being within the scope of the present invention. The control circuitry of the television control component may be implemented in a microprocessor 44. The television control component 40 may be housed in an enclosure comprising a front housing 46 and a back housing 47. The back housing 47 is provided with a 110 VAC plug 48 for plugging into a wall outlet 41. The 110 VAC plug 48 is electrically connected to a circuit board 49 that holds the IR transmitter(s) 42, current sensor 43, microprocessor 44, and RF transmitter 45. The enclosure is completed with a translucent top 55 and the IR transmitter(s) 42 are situated so as to radiate through the translucent top 55. The front housing 46 is provided with a plug-in 56 for receiving a plug from the television 20. The television control component 40 may also be provided with a keyswitch 57 for controlling the functions of the television control component 40. A visual indicator 58, such as an LED, of the operating status of the television control component 40 may also be provided on the front enclosure 46.

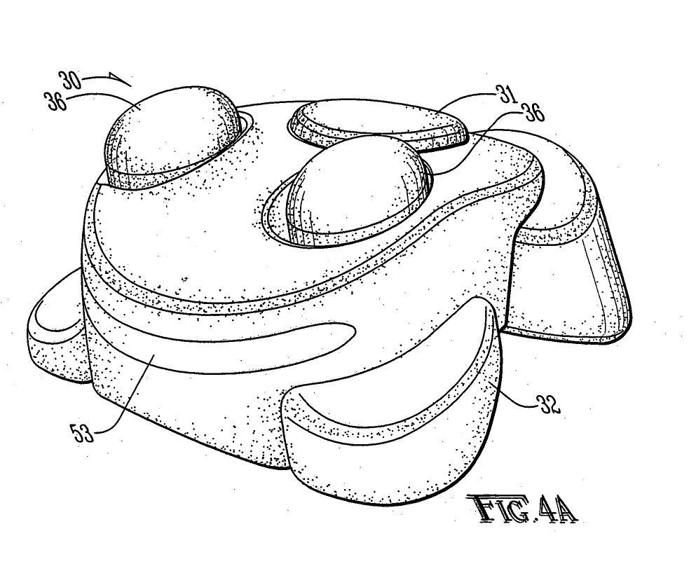

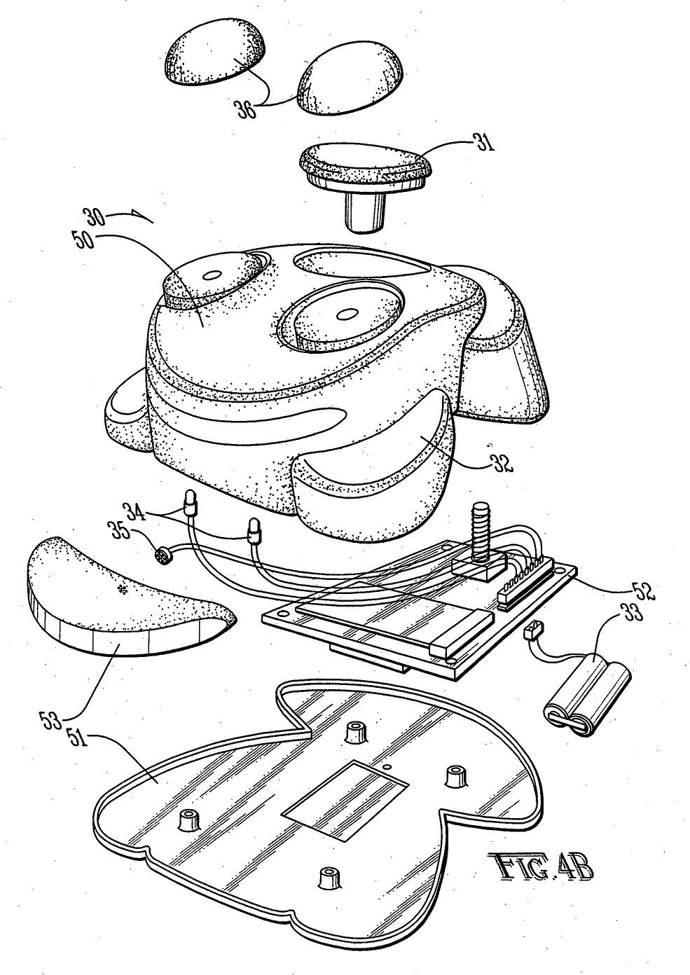

With further reference to FIG. 3, if the user 10 fails to press the switch 31 during any window period, a “turn off” signal is sent to the television 20. In one embodiment of the present invention, after the television 20 is turned off for lack of a valid retrigger, the television 20 may be turned on immediately by pressing the switch 31. In an alternative embodiment, there may be a delay period after there has been a failure to press the switch 31 during the window period. In this embodiment, pressing the switch 31 during the delay period would not result in a “turn on” signal being sent to the television 20. However, if the switch 31 is pressed while not within a window period, and it has been more than the predetermined time limit, e.g., five seconds, since the remote control component 30 sent a “turn off” signal due to the lack of a valid retrigger during the window period, the remote control component 30 will send a “turn on” signal to the television control component 40.

As shown in FIG. 3, the television 20 is initially in the OFF state. The user 10 presses the switch 31 at time A and the television control component 40 uses the IR transmitter 42 to turn the television 20 ON. The interval is initially set to 15 seconds and the window period opens during the last 5 seconds. If the user 10 does not press the switch 31 during the window period, the television is turned OFF as shown at time B. Depending on whether a delay is built into the system, the user may then press the switch 31 to turn the television ON or may be required to wait out the delay period before the television can be turned ON. Assuming no delay period is required, the user 10 may turn the television 20 ON by immediately pressing the switch 31 as shown at time C. The initial interval remains 15 seconds and the window period opens during the last 5 seconds. Pressing the switch 31 on the remote control component 30 during the window period resets the interval and the RF transmitter 38 sends a “turn on” signal to the television control component 40. The remote control component 30 then begins to count down the interval. The duration of the interval period may vary as described below. At the end of the interval, the window period opens and the user 10 is alerted to the opening of the window period. If no valid retrigger occurs during the window period, at the end of the interval, the remote control component 30 sends a “turn off” signal via the RF transmitter 42 to the television control component 40.

The remote control component 30 has two timers in it. The first timer defines the interval period. The second timer opens the window period at the end of the interval period during which a valid retrigger may occur. Both timers may be implemented in microprocessor 37. The switch 31 must start from a non-pressed state and then be pressed during the window period to effect a valid retrigger. The user 10 may be alerted to the window period by various combinations of continuous and intermittent signals. Preferably, at the start of the window period, there is an audible alert. During the window period, until the switch 31 is pressed correctly, a visible alert is preferably generated.

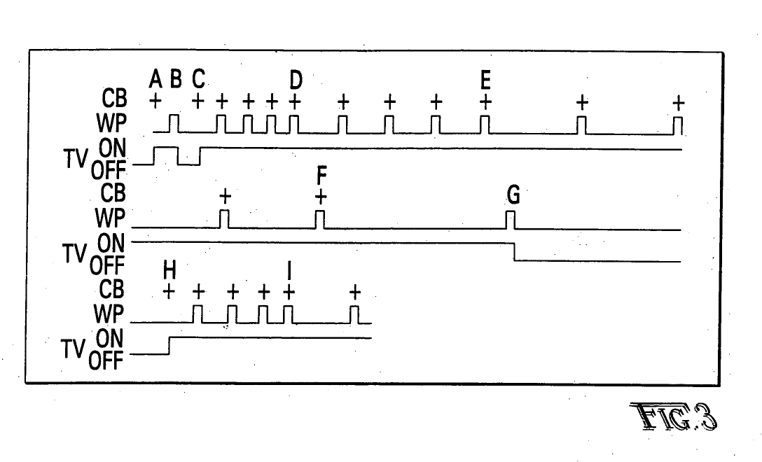

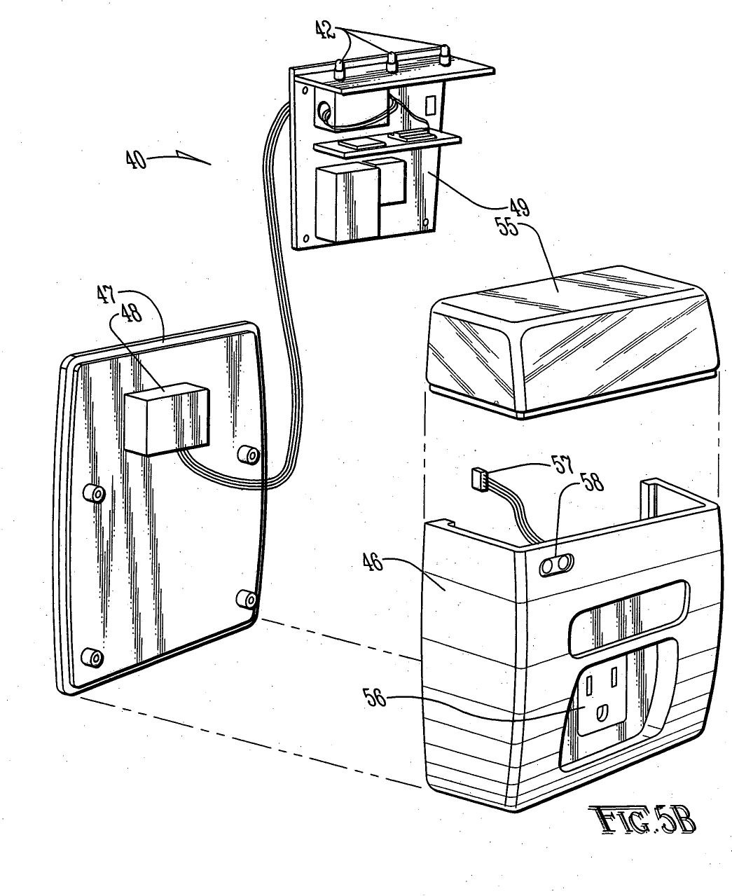

With reference to FIGS. 2B and 5B, the television control component 40 preferably comprises a power supply (not shown), a current sensor 43 to determine whether the television 20 is on, a microprocessor 44 and an IR transmitter 42. When the television control component 40 receives a “turn on” signal, it checks the status of the television 20 via the current sensor 43. If the sensor 43 detects only stand-by current going to the television 20, the television control component 40 sends an IR signal to the television 20. Televisions typically use the same IR code to both turn on and turn off the television by toggling its internal power switch each time it receives the code. If the television control component 40 receives a “turn on” signal and senses that the television 20 is already on, it does not send any IR signal to the television 20.

In the embodiment just described, the RF signals are one-way only, from the remote control component 30 to the television control component 40. Alternatively, by implementing RF transmitter 38 and RF receiver 45 as transceivers, two-way RF communication may be provided to allow the television control component 40 to confirm to the remote control unit 30 that it received an RF signal. If the remote control unit 30 does not receive an immediate confirmation, it may resend the signal. Two-way RF communication therefore makes the system more immune to radio frequency interference.

With reference to FIG. 3, the interval period may be varied depending on the behavior of the user. For example, the interval period may be initially set at a brief interval, such as 15 seconds. The window period may be the last 5 seconds of the interval period. If during each of a fixed number of consecutive window periods, for example, four window periods, there has been a valid retrigger, the interval period may be increased, for example to 30 seconds as shown at time D. If during each of the following four window periods in succession, there is a valid retrigger, the interval period is increased again to one minute as shown at time E. If there are four valid retriggers during the next four window periods, the interval period may be increased again to 2 minutes as shown at time F. If there is no valid retrigger during a window period as shown at time G, the television 20 is turned off. When the television 20 is turned on again as shown at time H, the interval period has been reset to the initial 15 seconds. Four valid retriggers will increase the interval period to 30 seconds as shown at time I.

The present invention can be designed to work with various models of televisions. There are a variety of different IR codes used by different manufacturers to turn their respective televisions on and off. In order to handle the majority of televisions on the market, it is desirable that the television control component 40 have an IR sensor 59, such as a photodetector, operatively connected to the microprocessor 44. The user 10 may then put the television control component 40 into a learn mode and then press the power button on the factory-supplied remote for the user's particular model of television. The television control component 40 will then receive the IR code specific to that model of television and store the code in non-volatile memory. The television control component 40 will then have the proper IR code to send to the television 20 to turn it on or off as required.

The television control component 40 may include a keyswitch 57 for selecting between normal television use, use with the remote control component 30 and the learn mode as described above.

The present invention has been described with reference to certain preferred and alternative embodiments that are intended to be exemplary only and not limiting to the full scope of the present invention as set forth in the appended claims.

What is claimed is:

1. A behavioral attention control apparatus for use by a user with a television, comprising:
a television on/off controller;
a first timer in communication with said television on/off controller, said first timer defining an interval period during which the television on/off controller maintains the television in an on state;
a second timer defining a window period;
an alert activated during said window period; and
a switch whose activation by the user during said window period issues a valid retrigger signal to reset said interval period; and
means for providing electrical power to at least one of said television on/off controller, said first timer, said second timer, said alert and said switch; and
wherein said first timer progressively lengthens said interval period if the user makes a valid retrigger during a predetermined number of consecutive window periods.

2. The apparatus of claim 1, wherein the television has an infrared remote control, further comprising:
a remote control component housing said first timer, said second timer, said alert and said switch;
said remote control component further comprising means for communicating with said television controller; and
wherein said television controller comprises a television control component comprising
means for communicating with said remote control component, and
an infrared transmitter for transmitting control signals to the television.

3. The apparatus of claim 2, wherein said means for communicating with said television controller comprises a radio frequency transmitter; and
wherein said means for communicating with said remote control component comprises a radio frequency receiver.

4. The apparatus of claim 2, wherein said means for communicating with said television controller comprises a radio frequency transceiver; and
wherein said means for communicating with said remote control component comprises a radio frequency transceiver.

5. The apparatus of claim 2, wherein said television control component further comprises a current sensor.

6. The apparatus of claim 2 wherein said remote control component comprises an enclosure shaped like an animal.

7. The apparatus of claim 6 wherein said remote control component comprises an enclosure shaped like a frog having eyes, and wherein said alert comprises a visual alert comprising light emitting diodes disposed to illuminate said eyes and an audible alert comprising a frog-like sound.

8. The apparatus of claim 1 wherein said means for providing electrical power comprises a battery.

9. The apparatus of claim 8, wherein said battery is rechargeable.

10. The apparatus of claim 2, wherein said television control component further comprises a learn mode.

11. A method of behavioral attention control of a user of a television, comprising the steps of:
(a) providing a television on/off controller, a first timer for counting down an interval during which the television is maintained by the television on/off controller in an on state, a switch controlled by the user, a second timer for defining a window period during which activation of the switch by the user resets the interval, and an alert for alerting the user when the window period is open;
(b) turning the television on;
(c) counting down an initial interval;
(d) opening the window period and alerting the user that the window period is open; and
(e) turning the television off if the user does not activate the switch during the window period or resetting the interval if the user activates the switch during the window period;
(f) repeating steps (c) through (e) and if the user activates the switch during each of a predetermined consecutive number of window periods, lengthening the interval for each subsequent interval.

12. The method of claim 11 wherein at least one of said television on/off controller, said first timer, said second timer, said alert and said switch are housed in an enclosure shaped like an animal.

13. The method of claim 12 wherein said enclosure is shaped like a frog having eyes, and wherein said alert comprises a visual alert comprising light emitting diodes disposed to illuminate said eyes and an audible alert comprising a frog-like sound.

14. The method of claim 11 wherein said visual alert is active during the entire window period and said audible alert is activated to indicate the start of the window period.

15. The method of claim 11 wherein said window period is five (5) seconds.

16. The method of claim 11 wherein said predetermined consecutive number of window periods is four (4).

17. The method of claim 11 wherein said initial interval is fifteen (15) seconds.

18. The method of claim 11 wherein said subsequent interval is selected from the group comprising thirty (30) seconds, sixty (60) seconds, and one hundred and twenty (120) seconds.

19. A behavioral attention control apparatus for use by a user with a television, comprising:
a television on/off controller;
a first timer in communication with said television on/off controller, said first timer defining an interval period during which the television on/off controller maintains the television in an on state;
a second timer defining a window period;
an alert activated during said window period; and
a switch whose activation by the user during said window period issues a valid retrigger signal to reset said interval period; and
means for providing electrical power to at least one of said television on/off controller, said first timer, said second timer, said alert and said switch.

20. The apparatus of claim 19, wherein the television has an infrared remote control, further comprising:
a remote control component housing said first timer, said second timer, said alert and said switch;
said remote control component further comprising means for communicating with said television controller; and
wherein said television controller comprises a television control component comprising
means for communicating with said remote control component, and
an infrared transmitter for transmitting control signals to the television.

21. The apparatus of claim 20, wherein said means for communicating with said television controller comprises a radio frequency transmitter; and
wherein said means for communicating with said remote control component comprises a radio frequency receiver.

22. The apparatus of claim 20, wherein said means for communicating with said television controller comprises a radio frequency transceiver; and
wherein said means for communicating with said remote control component comprises a radio frequency transceiver.

23. The apparatus of claim 20, wherein said television control component further comprises a current sensor.

24. The apparatus of claim 20 wherein said remote control component comprises an enclosure shaped like an animal.

25. The apparatus of claim 24 wherein said remote control component comprises an enclosure shaped like a frog having eyes, and wherein said alert comprises a visual alert comprising light emitting diodes disposed to illuminate said eyes and an audible alert comprising a frog-like sound.

26. The apparatus of claim 19 wherein said means for providing electrical power comprises a battery.

27. The apparatus of claim 26, wherein said battery is rechargeable.

28. The apparatus of claim 20, wherein said television control component further comprises a learn mode.

29. A method of behavioral attention control of a user of a television, comprising the steps of:
(a) providing a television on/off controller, a first timer for counting down an interval during which the television is maintained by the television on/off controller in an on state, a switch controlled by the user, a second timer for defining a window period during which activation of the switch by the user resets the interval, and an alert for alerting the user when the window period is open;
(b) turning the television on;
(c) counting down an initial interval;
(d) opening the window period and alerting the user that the window period is open; and
(e) turning the television off if the user does not activate the switch during the window period or resetting the interval if the user activates the switch during the window period.

30. The method of claim 29 wherein at least one of said television on/off controller, said first timer, said second timer, said alert and said switch are housed in an enclosure shaped like an animal.

31. The method of claim 30 wherein said enclosure is shaped like a frog having eyes, and wherein said alert comprises a visual alert comprising light emitting diodes disposed to illuminate said eyes and an audible alert comprising a frog-like sound.

32. The method of claim 29 wherein said visual alert is active during the entire window period and said audible alert is activated to indicate the start of the window period.

33. The method of claim 29 wherein said window period is five (5) seconds.

34. The method of claim 29 wherein said predetermined consecutive number of window periods is four (4).

35. The method of claim 29 wherein said initial interval is fifteen (15) seconds.

36. The method of claim 29 wherein said subsequent interval is selected from the group comprising thirty (30) seconds, sixty (60) seconds, and one hundred and twenty (120) seconds.
